(19) United States
(12) Patent Application Publication
(10) Pub. No.: US 2013/0236703 A1
(43) Pub. Date: Sep. 12, 2013

(54) ROLLED DECORATIVE ADHESIVE TAPE PRODUCT

(71) Applicant: Scott A. Sommers, Avon Lake, OH (US)

(72) Inventor: Scott A. Sommers, Avon Lake, OH (US)

(73) Assignee: Shurtech Brands, LLC

(21) Appl. No.: 13/412,990

(22) Filed: Mar. 6, 2012

(51) Int. Cl. B32B 3/00

(52) U.S. Cl. 428/195.1

(57) ABSTRACT

An image is divided into several segments of uniform width and printed on a backing which is used to make adhesive tape wound upon a roll allowing a user to apply the image to a substrate by separating successive image segments from the roll and applying them to a substrate.

### FIELD OF THE INVENTION

This invention relates to adhesive tape and more particularly to plastic backed adhesive tape such as duct tape, packaging tape or office tape.

### BACKGROUND OF THE INVENTION

Duct tape and packaging tape are products widely available to consumers. Duct tape and packaging tape often are of a uniform color. Some duct tape products have designs printed on the backing.

Duct tape and packaging tape are available rolled upon a core in widths of 48 millimeters or two inches. The length of the tape in a particular product varies from a few yards, such as 10 yards in length to many yards, such as 60 yards in length and more.

### SUMMARY OF THE DISCLOSURE

A rolled decorative adhesive tape product comprises an elongate backing of uniform width with an adhesive coated on one side of the backing and several different discreet image segments printed on the other side of the backing sequentially allowing the construction of an entire image wider than the backing width by separating succeeding image segments and applying the image segments to a substrate in parallel, adjacent and aligned relationship.

Further in accordance with the disclosure, a decorative adhesive tape product can contain image segments repeating multiple copies of the same entire image or segments forming multiple different entire images or a combination of the two.

Yet further in accordance with the disclosure, the rolled adhesive tape product has a low tack adhesive coating allowing the tape and image to remove from the substrate.

Still further in accordance with the disclosure the rolled adhesive tape product includes retroreflective portions allowing the construction of an informational image of large size visible at night from a two inch wide roll of tape.

Yet further in accordance with the disclosure, the image segments are separated from one another on the rolled product by perforations.

### OBJECTS OF THE DISCLOSURE

It is the primary of the disclosure to provide a roll of tape product allowing a user to construct a large image on a substrate easily from a compact product.

It is yet another object of the disclosure to provide a roll of tape product allowing non-professionals to easily and neatly apply large images to a substrate using a compact roll of adhesive tape.

It is still another object of the present disclosure to provide a rolled adhesive tape product allowing the construction of large informational images visible at night quickly without a complicated application process.

These and other objects of the disclosure will become more fully apparent in the following specification and the attached drawings.

### BRIEF DESCRIPTION OF THE DRAWINGS

FIG. 1 is a schematic presentation of a rolled decorative adhesive tape product with the leading portion of the tape pulled away from the roll displaying image segments;

FIG. 2 is a plan view of a entire image wider than the roll of tape seen in FIG. 1 constructed from the image segments seen in FIG. 1;

FIG. 3 is a view similar to FIG. 1 displaying a different set of image segments;

FIG. 4 is a plan view similar to FIG. 2 showing a different entire image;

FIG. 5 is a view similar to FIGS. 1 and 3 illustrating a rolled decorative adhesive tape product containing image segments for two different entire images;

FIG. 6 is a plan view similar to FIGS. 2 and 4 showing the two different images constructed from the segments created from the roll of tape seen in FIG. 5;

FIG. 7 is a plan view similar to FIG. 6 showing an informational entire image constructed from tape segments on a single roll of tape;

FIG. 8 is a block diagram of a process for making a decorative adhesive tape product;

FIG. 9 is a schematic illustration of a backing blank used in creation of the rolled decorative adhesive tape product; and,

FIG. 10 is an illustration of a second backing blank used in creating the disclosed rolled decorative adhesive tape product.

### DESCRIPTION OF THE PREFERRED EMBODIMENTS

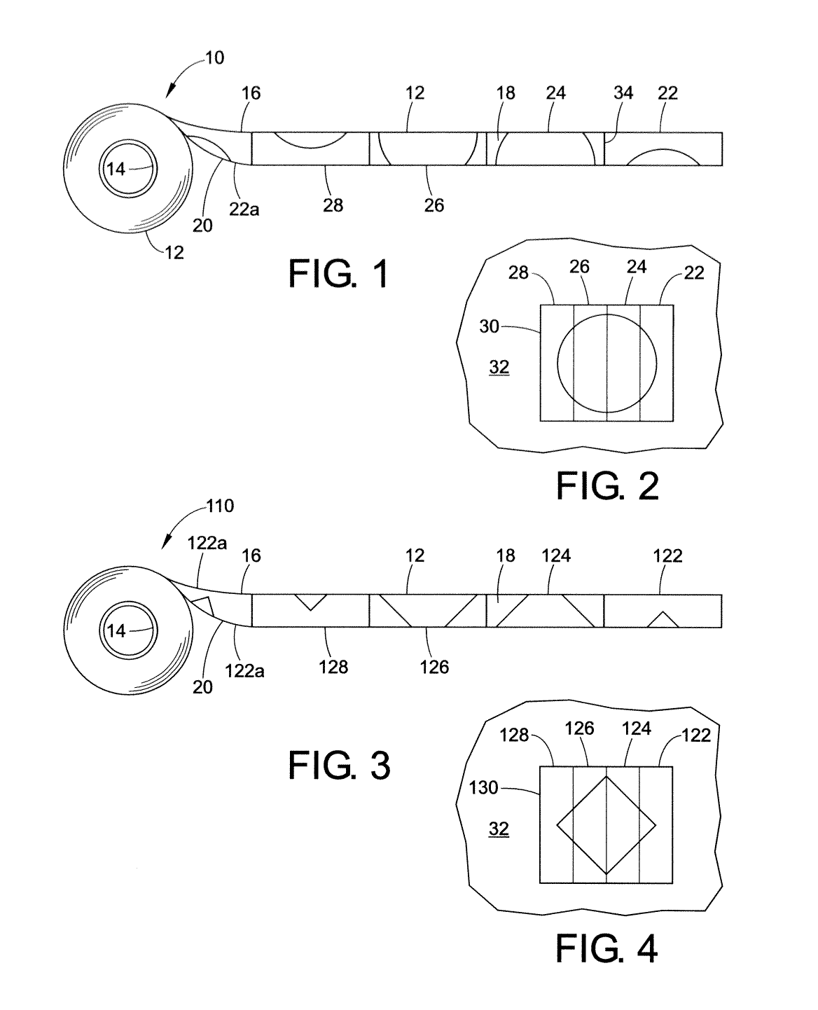

Referring now to the drawings wherein the showings are for the purposes of illustrating preferred embodiments and not for the purposes of limiting the disclosure, FIG. 1 shows an adhesive tape product 10 comprised of a length of adhesive tape 12 wound upon a core 14. The core 14 is conventional and is either a plastic cylinder or cardboard cylinder or the like. The length of tape 12 comprises a plastic backing 16 with a printed design on a first side 18 and an adhesive on a second side 20. The printed design comprises several different discreet image segments arranged sequentially upon the first side 18 of the plastic backing 16. In the embodiment seen in FIG. 1, a first image segment 22 is seen on the very leading edge (the right end). Directly adjacent the first image segment is a second image segment 24 followed by a third image segment 26 and a fourth image segment 28. Directly adjacent the fourth image segment 28 is a repeat of first image segment 22a. Adjacent image sections may be separated by perforations, notches in the edges of the tape or otherwise made easily separable. Alternatively, the image segments may be printed on unperforated, unnotched tape for separation with scissors. Each of the image segments 22, 24, 26, 28 differ one from the other. Although they may be symmetrical or otherwise seem to repeat.

The image segments are separated from the roll of tape product 10 and applied to a substrate as seen in FIG. 2 constructing an image having an overall width significantly wider than the width of the roll of tape product 10. While the entire image 30 displayed in FIG. 2 is rather simple, more complex images are provided in the same way as the simple entire image 30 seen in FIG. 2. Thus, image segments are separated from the adhesive tape product 10, applied to a substrate 32 in parallel, adjacent an aligned relationship and the entire image 30 is completed. The substrate 32 can be anything from a wall, to the fender of an automobile, to a window or any other relatively receptive surface. The surface can be flat or gently curved or more aggressively curved. The substrate can have a smooth surface or a more texture surface such as concrete. The adhesive used can be of higher tack adhesive such as used on standard duct tape or a releasable adhesive allowing the entire image 30 to be removed from the surface without leaving an adhesive residue when desired. The film used as the plastic backing 16 can also be a light transparent film or a heavier stronger film such as used in conventional duct tape. The image segments on the tape can be separated one from the other by simple discontinuities in the images, marking such as dashed black print, or perforations 34 as shown in FIG. 1. Perforations make it easy to tear apart image segments one from the other without the use of a tool such as a knife or pair of scissors.

FIG. 3 shows another adhesive tape product 110 identical in all respects to the first adhesive tape product 10 except that a different set of image segments 122, 124, 126, 128 are printed onto the tape plastic backing 16.

FIG. 4 shows the four image segments 122, 124, 126, 128 applied to a substrate 32 in parallel, adjacent and aligned relationship forming a second entire image 130.

As in FIG. 1, the adhesive tape product contains multiple sequences of image segments. Thus, image segment 122a which is a repeat of image segment 122, appears to the left of image segment 128. This starts the presentation of image segments and sequence again after the first sequence. This continues for the entire roll of tape.

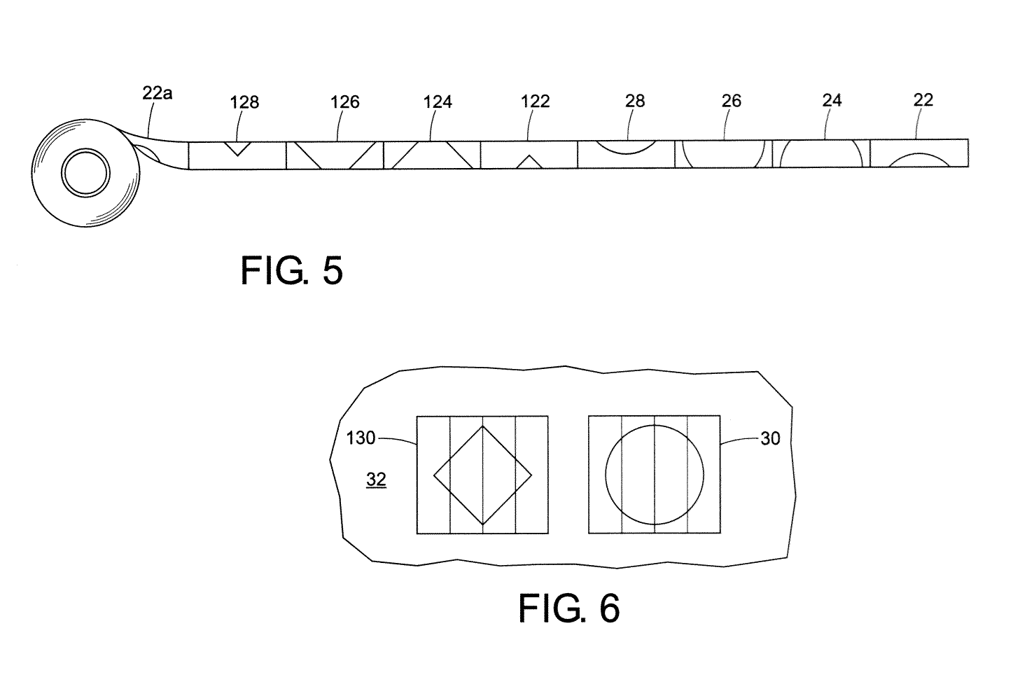

FIG. 5 shows another adhesive tape product 210 identical to the adhesive tape product seen in FIG. 1 except for the image segments on the tape. The first four segments (from the right) are identical to the segments seen in FIG. 1 and are identically numbered, 22, 24, 26, 28. The following segments, however, are not identical to the first four segments of the first adhesive tape product 10, but rather identical to the first four segments on the second adhesive tape product 110 and the segment visible in FIG. 5 is identified as segments 122, 124, 126, 128. These image segments are followed by a repeat of the first image segment marked 22a. The first eight image segments separated from the third adhesive tape product 210 are shown arranged in parallel adjacent relationship on a substrate 32 in FIG. 6. Two complete images 30, 130 are thereby created as shown in FIG. 6. These two completed images can be disposed on the same substrate or on different substrates. The two images can be separated from the roll of tape at the same time and placed upon the same substrate or the first image 30 can be separated and used and the second image 130 can be left on the tape product 210 for separation and application to a substrate at a later time. More than two complete images 30 and 130 can be contained on a single roll. Thus, it is contemplated that adhesive tape products 10, 110, 210 can contain repeats of multiple image segments forming repeats of only one image or can intermix two different images or three or more images. The unifying concept is that multiple image segments are sequentially available on the tape for separation and application to a substrate to create an image having a width larger than the uniform width of the tape itself. The images can be as simple as the diamond and circle shapes as seen or more complex, for instance, reproductions of popular posters, reproductions of music covers, safety images, maintenance images, and other images can be deconstructed into uniform width strips, printed on tape as described, and constructed into large images on a substrate as described above. More than four image segments can be used to form an image. Less than four image segments can be used to form an image.

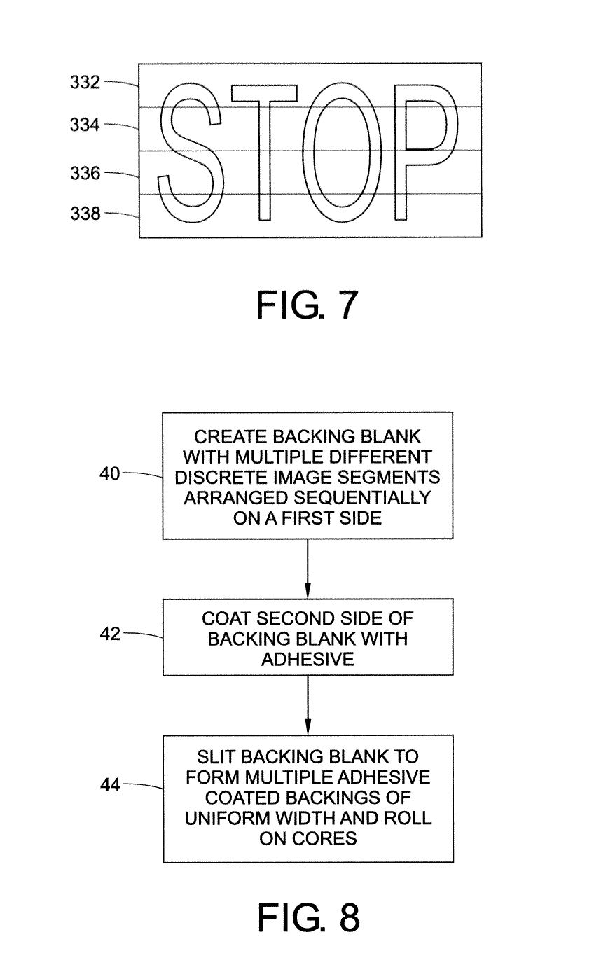

FIG. 7 shows another image constructed from image segments originally distributed on a roll of tape such as the adhesive tape product 10. The adhesive tape product from which the image is constructed is a two inch wide duct tape-like product with four repeating image segments 332, 334, 336, 338 separated from the roll of tape and applied to a substrate in a parallel adjacent aligned relationship. As can be seen in FIG. 7, when the four segments are properly aligned, a sign eight inches high and about two feet wide presenting the letters “stop” is created. The letters are segmented for easy printing and storage on a roll of tape. The letters can be printed in retro-reflective ink with substantial width of the bodies of the letters. In this way, a police officer can carry a roll of tape or several rolls of tape in the trunk of his car. If a stop sign is found to be missing or damaged or destroyed in an accident, weather incident or otherwise, the officer can apply a substitute sign on an adjacent tree trunk, or any other appropriate surface as a temporary replacement. Because the sign is stored on a roll of tape, it is easily kept in the trunk of a police car and easily found and used when needed.

Even larger signs can be created using more tape segments. Thus, eight tape segments can be used to make a 16 inch high sign for use on interstate highways. An officer could apply a “reduce speed” message temporarily over a sign giving distance to a nearby city in an emergency situation. The tape is a duct tape with a message on it. The adhesive is sufficiently strong to stay on such substrates through a snow storm or other event requiring temporary signage.

FIG. 8 illustrates the steps in creating the adhesive tape products 10 described above in block diagram form. In an image creation step 40, the image or images to be put on the tape are selected, the size of the image selected, and the image divided into segments for sequential printing on backing. Adhesive tape products are often manufactured using a backing of considerable width (several yards) which is later slit to appropriate width. Thus, images for many rolls of tape will be printed at the same time on a wide backing blank. This may include the printing of completed images which are divided into segments during the slitting operation. No matter how the images are arranged, the aim is that sequential image segments are provide on each finished roll of tape with all the image segments needed to create one complete image being adjacent on another. The printed backing blank is then coated in the coating step 42 with appropriate primers, release agents and adhesive. This coating step is conventional.

The coated backing blank is then slit to appropriate width, cut to appropriate length and rolled on cores in the slitting step 44. The slitting step is also conventional.

The cores may be printed with appropriate product information such as length of tape, distributor name, image printed on tape and the like. Some products 10 are finished after the slitting and rolling state. Other products will require further packaging for compliance with consumer packaging requirements, consumer preferences, and the like.

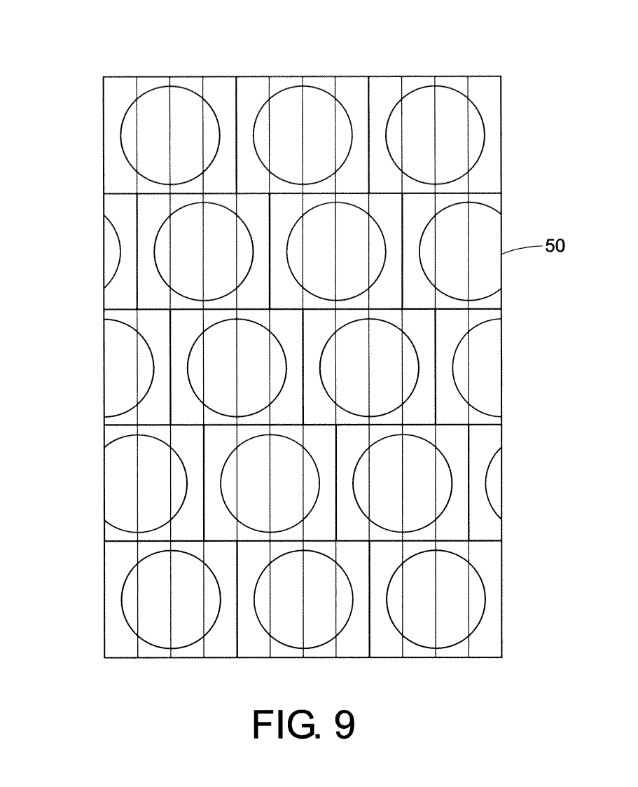

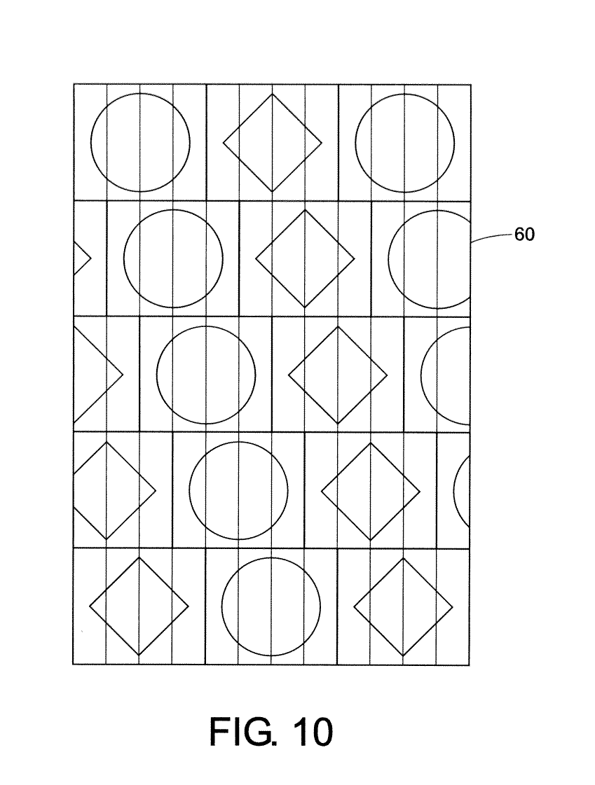

FIGS. 9 and 10 illustrate backing blanks as created in the image creation step 40. With respect to FIG. 9, a backing blank 50 is shown which is wide enough to form twelve rolls of tape. This is undersized when compared to many commercial tape production methods. However, this size is sufficient to illustrate the concept. Actual backing blanks will be considerably wider carrying considerably more images to make more rolls of tape. In FIG. 10, multiple copies of the same image are seen. The images are repeated one after the other along the length of the tape blank and also transversely across the width of the blank. Each succeeding image is displaced one step (a tape width) to the left in the longitudinal direction. In this way, image segments are staggered and image segments on each roll of tape are presented in a one, two, three, four order with each set of four creating a completed image when applied to a substrate. Obviously, the length of segments can vary with the size of the image desired. Additionally, the number of segments can vary depending upon the size of the complete image desired.

FIG. 10 is similar to FIG. 9 except that it shows two different images on the same backing blank 60. The images are staggered so that a first image is presented on each roll of tape in a one, two, three, four order followed by the second image also presented in a one, two, three, four order. These two sequences can be followed by a repeat of the two images for as long as the roll of tape lasts or more than two images can be supplied.

Large, detailed, readable images with bright colors, retroreflective areas, fluorescent areas, phosphorescent areas, transparent areas, and high contrast areas, can be provided. Thus, high quality decorative graphics can be easily applied to a substrate permanently or temporarily depending upon the adhesive selected. Moreover, temporary emergency signage which is precomposed, extremely readable and of appropriate size can be applied quickly with little training in an emergency situation. Such signage can improve safety on highways, at airports, or anywhere else where people may need clear readable directions in dealing with unusual situations. The graphics and signage are easily and safely sold and transported rolled as tape upon a core. They are not subject to easy damage and are easily applied without the need for training or special tools.

While considerable emphasis has been placed herein on the structures of the preferred embodiments, it will be appreciated that many modifications and alterations can be made in the embodiments herein illustrated and described without departing from the principles of the disclosure. Further, changes to details of the structure of the tape product will occur to others. Accordingly, it is to be distinctly understood that the foregoing descriptive matter is to be interpreted merely as illustration of the present disclosure and not as a limitation. Obviously, modifications and alterations will occur to others upon the reading and understanding of this specification. It is intended to include all such modifications insofar as they come within the scope of the appended claims or the equivalents thereof. Having thus, described the invention, it is claimed:

1. A rolled decorative adhesive tape product comprising a roll of an elongate backing of uniform width; the elongate backing having a first side and a second side; an adhesive coating on the second side of the elongate backing; several different discrete image segments on the first side of the elongate backing arranged serially whereby an entire image wider than the backing width can be constructed by separating succeeding image segments from the roll and applying the image segments to a substrate in parallel, adjacent and aligned relationship.

2. The rolled adhesive tape product of claim 1 wherein multiple copies of each image segment are provided on a single roll.

3. The rolled adhesive tape product of claim 1 wherein the roll of tape contains at least two sets of different discrete image segments arranged sequentially on the roll whereby at least two separate entire images can be constructed by separating succeeding image segments from the roll and applying image segments to a substrate in parallel, adjacent and aligned relationship.

4. The rolled adhesive tape product of claim 1 wherein the adhesive coating is a low tack adhesive coating allowing the tape to be removed from a substrate.

5. The rolled adhesive tape product of claim 1 wherein the image segments include retroreflective portions.

6. The rolled adhesive tape product of claim 1 wherein the image segments are separated by perforations.
